(19) United States
(12) Patent Application Publication
(10) Pub. No.: US 2015/0341285 A1
(43) Pub. Date: Nov. 26, 2015

(54) METADATA TRANSPORT BETWEEN MOBILE NETWORK CORE AND EXTERNAL DATA NETWORK

(71) Applicant: Akamai Technologies, Inc., Cambridge, MA (US)

(72) Inventors: Ravi S. Aysola, Acton, MA (US); Brian B. Mullahy, Leominster, MA (US); Rangan V. Suresh, Acton, MA (US); James V. Luciani, Acton, MA (US)

(73) Assignee: AKAMAI TECHNOLOGIES, INC., Cambridge, MA (US)

(21) Appl. No.: 14/719,293

(22) Filed: May 21, 2015

Related U.S. Application Data
(60) Provisional application No. 62/002,029, filed on May 22, 2014.

(51) Int. Cl. H04L 12/931; H04L 29/08; H04L 29/06

(52) U.S. Cl. CPC H04L 49/20; H04L 63/0428; H04L 67/2804

(57) ABSTRACT

Described herein are systems, methods, and apparatus for processing network packets in a computer network. According to the teachings hereof, distributed computing resources can be organized into a service platform to provide certain value-add services—such as deep packet inspection, transcoding, lawful intercept, or otherwise—using a service function chaining model. The platform can be used operate on traffic coming from or going to a mobile network (or other target network) to the public Internet. The platform may send to the mobile network various kinds of metadata related to or reflecting the services it is performing and/or the traffic that is flowing to or from the mobile network, among other things.

This application is based on and claims the benefit of priority of U.S. Provisional Application No. 62/002,029, filed May 22, 2014. The disclosure of the foregoing application is hereby incorporated by reference in its entirety.

This patent document may contain material subject to copyright protection. The copyright owner has no objection to the facsimile reproduction by anyone of the patent document or the patent disclosure, as it appears in Patent and Trademark Office patent files or records, but otherwise reserves all copyright rights whatsoever.

### BACKGROUND

1. Technical Field

The teachings hereof relate generally to distributed data processing systems, to service platforms for mobile networks and mobile network subscribers, and to communication techniques between mobile networks and other networks.

2. Brief Description of the Related Art

In many ways, mobile networks are distinct in nature from the public Internet. Mobile networks often have specialized network elements responsible for tasks relevant to the mobile network environment. Service Architecture Evolution (SAE) is the core network architecture of 4G/LTE networks. It consists of a radio access network and an evolved packet core (EPC). End-user-equipment (UE), typically smartphones or other wireless client devices, and eNodeB belong to the radio access network; the EPC network contains Mobility Management Entity (MME), Serving Gateway (SGW, corresponding generally to SGSN in earlier architectures), PDN Gateway (PGW, corresponding generally to GGSN in earlier architectures) and other elements.

The eNodeB is effectively a cellular base station that connects to the mobile network and communicates with UE devices directly. MME is responsible for tracking the UE equipment and facilitation of voice calls and data sessions. The primary function of SGW is to manage user-plane mobility. PGW is the anchor point for UE sessions towards the packet data network. PGW also incorporates policy enforcement features in a PCEF element (Policy & Charging Enforcement Function), which may be embedded in the PGW. Policy & Charging Rules Function (PCRF) generally maintains policy and charging rules, including subscriber information (such as account data and services the subscriber has signed up for), bearer and quality of service (QoS) information associated with end-points in the operator network. Rules and policies are typically pushed/pulled from the PCRF. A Home Subscriber Server (HSS) maintains a subscriber database need by other network elements. Typical deployment of these elements in a mobile network is shown in FIG. 7. FIG. 7 also shows the mobile network relative to other external data networks, which may be on the public Internet or connected to the mobile network via the public Internet.

Once session setup is complete between UE and EPC, with a default bearer and zero or more dedicated bearers, PGW acts as border node between mobile packet core and external data networks that make up the public Internet. The user traffic between UE and IP end points in the data network goes through the PGW the session is anchored on.

PGW strips Generalized Packet Radio Service Tunneling Protocol (GTP) tunnel headers from upstream bound packets (that is, packets headed to an end-point in the data network) and routes them to the proper destination either as IP packets or with proper tunnel (e.g., MPLS/GRE/IPSec) headers. Similarly, for downstream traffic, PGW locates the session pertinent to the downstream traffic and inserts appropriate GTP headers prior sending the packet towards UE. PGW is also responsible for applying any subscriber specific policies such as traffic prioritization, billing (which typically involves a PCEF function embedded in the PGW), and potentially services such as deep packet inspection (DPI), network address translation (NAT), if possible. Recently mobile network operators have moved towards an abstracted approach referred to as service function chaining or service chaining In this approach, each of the supported services can be modeled as combination of one or more service functions (SF), where the role of each SF is to perform a specific task on a network packet or set of packets. For a given service, the SFs are applied in a sequential or parallel manner, i.e., by directing network traffic through them in a specified manner. As noted, this method is known as service chaining, and those chains are typically referred to as service function chains. In a given network there may be multiple service chains. For example, a network may provide three service functions: a NAT service function, a DPI service function, and an SSL optimization service function. With these service functions, several combinations of service chains can be formed from these independent service functions:

$$NAT$$

$$NAT + DPI$$

$$NAT + DPI + SSL Optimization$$

$$DPI + SSL Optimization$$

$$…$$

The entity that links services into service chains, selects the appropriate chain for the received traffic is typically called a ‘classifier’ (also referred to as a ‘service classifier’). Various aspects of service function chaining are currently being standardized in an IETF working group (Service Function Chaining working group).

Where traffic is encrypted, however, it may not be possible for a mobile network operator to provide some services, whether using a service function chaining approach or not. That is because traffic between UE the external data networks may be encrypted. For a secure session, HTTPS runs over SSL/TLS, which uses negotiated keys to encrypt the payload content. When PGW receives such encrypted payload, it does not have visibility into the packet payload past IP headers and TCP headers and so cannot perform deep packet inspection or offer services that require access to encrypted payload. Also, some service-oriented billing (feature specific billing) may not be feasible for encrypted traffic, as determining the features being utilized may require access to the encrypted payload.

In the mobile core network, PGW is the last element where subscriber identity is terminated. The subscriber identity could be or include International Mobile Subscriber Identity (IMSI), IP address (pre-NAT if any) assigned to the bearer, IP address associated with Access Point Name (APN), APN associated with the bearer, International Mobile Equipment Identifier (IMEI), client device information, subscriber identity associated with specific services (such as an ID assigned by a mobile network operator), and/or others. Therefore, devices upstream to

PGW in the packet network do not have visibility into the identity of the UE device requesting the content.

### BRIEF DESCRIPTION OF THE DRAWINGS

The teachings hereof will be more fully understood from the following detailed description taken in conjunction with the accompanying drawings, in which:

FIG. 1 is a schematic diagram illustrating an embodiment of a known distributed computer system configured as a content delivery network (CDN);

FIG. 2 is a schematic diagram illustrating an embodiment of a machine on which a CDN server in the system of FIG. 1 can be implemented;

FIG. 3 is a schematic diagram illustrating an embodiment of a service provider platform that provides value added services to subscribers associated with a mobile network and/or the mobile network operator;

FIG. 4 is a schematic diagram illustrating an embodiment of a dynamic service chaining architecture for use in the service platform of FIG. 3;

FIGS. 5A-C are schematic diagrams illustrating an embodiment of packet processing logical flow, which may operate in the architecture shown in FIG. 4;

FIG. 6 is a block diagram illustrating hardware in a computer system that may be used to implement the teachings hereof; and,

FIG. 7 is a schematic diagram illustrating a mobile network platform, as known in the art.

### DETAILED DESCRIPTION

The following description sets forth embodiments of the invention to provide an overall understanding of the principles of the structure, function, manufacture, and use of the methods and apparatus disclosed herein. The systems, methods and apparatus described herein and illustrated in the accompanying drawings are non-limiting examples; the claims alone define the scope of protection that is sought. The features described or illustrated in connection with one exemplary embodiment may be combined with the features of other embodiments. Such modifications and variations are intended to be included within the scope of the present invention. All patents, publications and references cited herein are expressly incorporated herein by reference in their entirety. Throughout this disclosure, the term “e.g.” is used as an abbreviation for the non-limiting phrase “for example.”

Service Function Chaining Architecture with Service Provider Platform

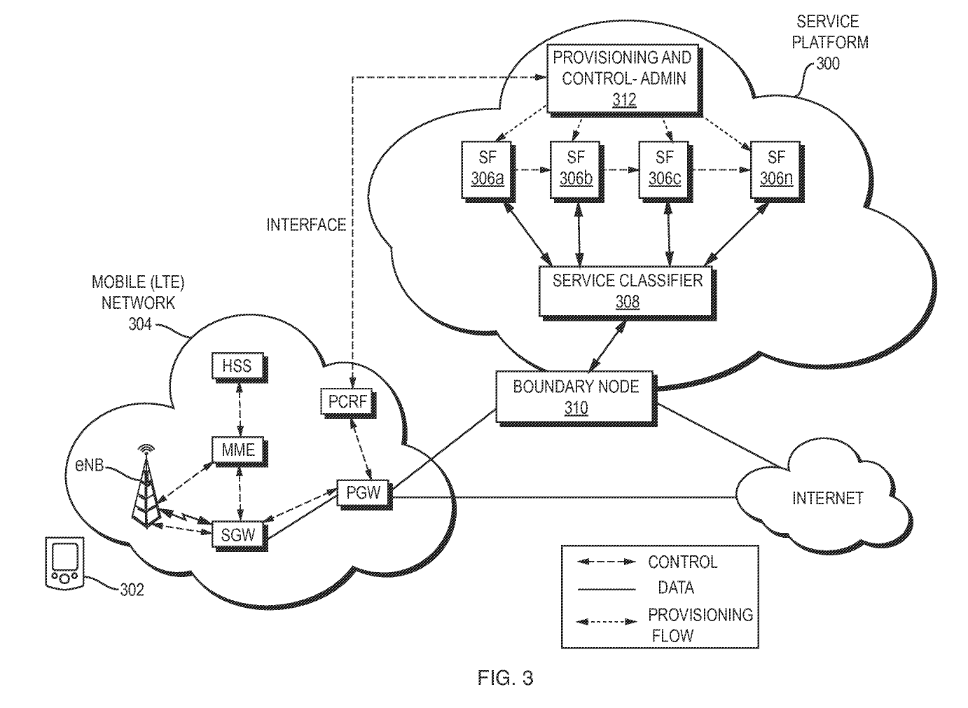

FIG. 3 illustrates an embodiment of platform 300 operated by a service provider (which could be a content delivery network service provider or otherwise) to provide value added services (VAS) to a mobile network operator and/or mobile network subscriber. It should be noted that while FIG. 3 illustrates a mobile network 304, the teachings hereof may be applied regardless of the type of network and network operator. In the description that follows, familiarity with conventional mobile network elements is presumed.

In the following text, the term “service provider” is used to refer to the service provider associated with the platform 300. The term “network operator”, “network provider” or “mobile network operator” is used to refer to the entity associated with the mobile network in FIG. 3.

With reference to FIG. 3:

The Provisioning/Control-Admin Interface is for policy, control and provisioning. This entity has a communication channel to a network element in the operator network 304—in this example, the network element is the Policy & Charging Rules Function (PCRF). This channel allows the service provider platform to send information to the network operator about the services that it performed and the end-user subscriber that it performed them for. For example, the service provider platform 300 can send a network subscriber identifier along with information identifying the services provided for that user. In this way, the service provider can charge the network operator for service and the network operator can charge its subscribers for the services provided in a service function chain.

The service classifier 308 is a node that classifies packets and builds service function chains.

The service function nodes 306a-n (labeled SF) host one or more service function instances built internally, configured from third party services, or otherwise. Some of the SF nodes 306 may be third party service nodes that implement certain functions for the value added service function chain.

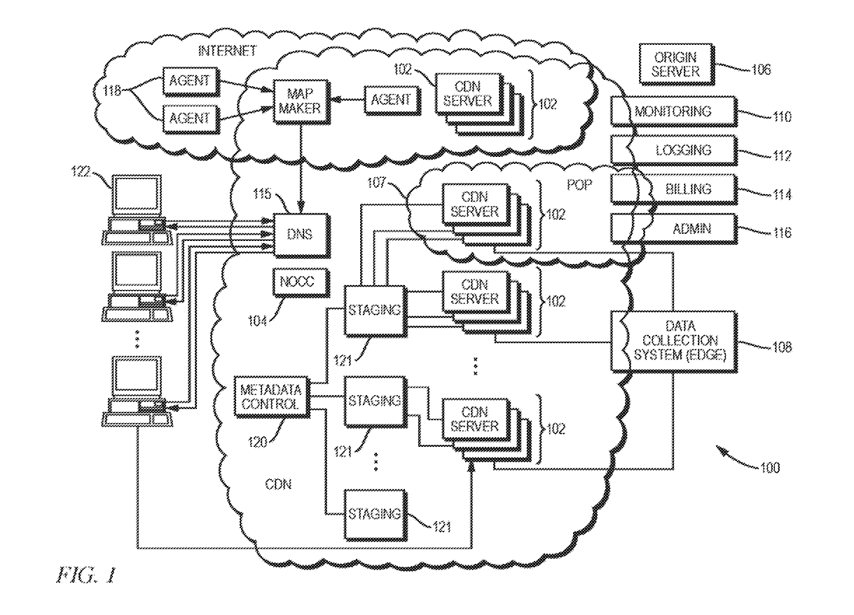

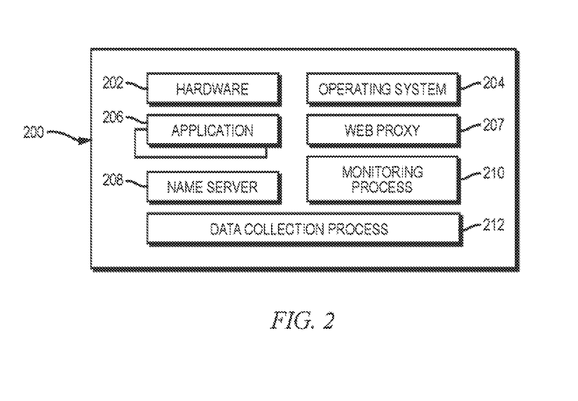

The boundary node 310 is the entry/exit point for traffic coming from the PDN Gateway (PGW) to the service provider platform 300, and for traffic going from the service provider platform to the PGW. Notably, the boundary node 310 may be, in some cases, a content server in a distributed content delivery platform such as a content delivery network (CDN). Typically, CDNs deploy content servers running an HTTP proxy and a providing a local content cache. The boundary node functionality can thus be layered or incorporated into machines that are part of this deployed platform. More information about content delivery networks and content servers is provided at the end of this disclosure and in FIGS. 1-2. With reference to those drawings and associated description, the boundary node 310 may be a CDN server 102. For encrypted traffic (such as SSL/TLS encrypted traffic or IPSec traffic) preferably the boundary node 310 decrypts the packets before sending them to the classifier 308. To this end, the boundary node 310 (and the service platform 300 generally) can use or has access to SSL/TLS private keys for the content providers who use the CDN (and the platform 300). The boundary node 310 may in some cases employ mechanisms to decrypt SSL/TLS traffic without locally-accessible private keys by offloading the decryption of an encrypted pre-master secret in the SSL/TLS handshake to an external server, as described in U.S. Patent Publication No. 2013/0156189, the teachings of which are hereby incorporated by reference.

Generalizing, in the upstream direction, a boundary node 310 can receive encrypted traffic that originated from a mobile network subscriber's client device 302 and that is egressing the mobile network 304, e.g., through PGW or other network element. The boundary node 310, with access to decryption information such as SSL/TLS private keys, is able to decrypt the traffic, establish a secure (SSL/TLS) session with the client device 302, and then perform certain value-added-services on traffic from the client device 302. The traffic then proceeds to a content provider origin in the Internet, or is returned to the mobile network 304 and/or the client device 302, depending on the particular function. The service platform 300 can likewise perform value-added services on downstream traffic headed to the client device 302, encrypting it in the session before sending it through the gateway to the client device 302.

The Policy and Control/Admin 312 is responsible for the providing the administrative interface for the service function chaining domain. Preferably it also provisions identifiers for the service function nodes 306a-n, service function chains, and classification rules to various service function nodes 306a-n and service classifier 308. The interfaces (to the PCRF, the SF nodes 306a-n, and/or the service classifier 308) is implementation dependent and can be RESTful.

FIG. 3 also shows a mobile network 304 with conventional mobile network components, such as a PDN Gateway (PGW), which serves as the anchor point for user-equipment (also referred to herein as a client device 302) sessions towards the data packet network and manages policy enforcement features; mobile management entity (MME) for tracking the user equipment and facilitating voice and data sessions; a serving gateway (SGW), to manage user-plane mobility; a Home Subscriber Server (HSS), for maintaining a subscriber database needed by other network elements; and as mentioned above, Policy & Charging Rules Function (PCRF), for maintaining policy and charging rules, including subscriber information (such as account data and services the subscriber has signed up for), bearer and QoS information associated with end-points within the operator network. The rules and policies are typically pushed/pulled from the PCEF (Policy & Charging Enforcement Functions) such as PGW, Gateway GRPS Support Node (GGSN), CDMA Home Agents of HRPD Serving Gateway (HSGW). In the systems and methods described herein, these components function in a conventional manner, as modified by the teachings hereof.

FIG. 3 also shows an interface from the PGW to the Internet and an interface from PGW to the service platform 300 (or more particularly, to the Boundary Node). These may be LAN connections such as an S(Gi) interface. However, those particular network configuration and interfaces are not limiting to the teachings hereof. Further, it should be noted that while FIG. 3 depicts a service provider platform 300 external to the network operator, many of the teachings hereof also apply where a network operator establishes its own platform as part of its own network, or invites deployment of the service platform into the mobile network 304 itself. Also, the service platform 300 may be machines deployed throughout the Internet.

Service Chaining Architecture Detail

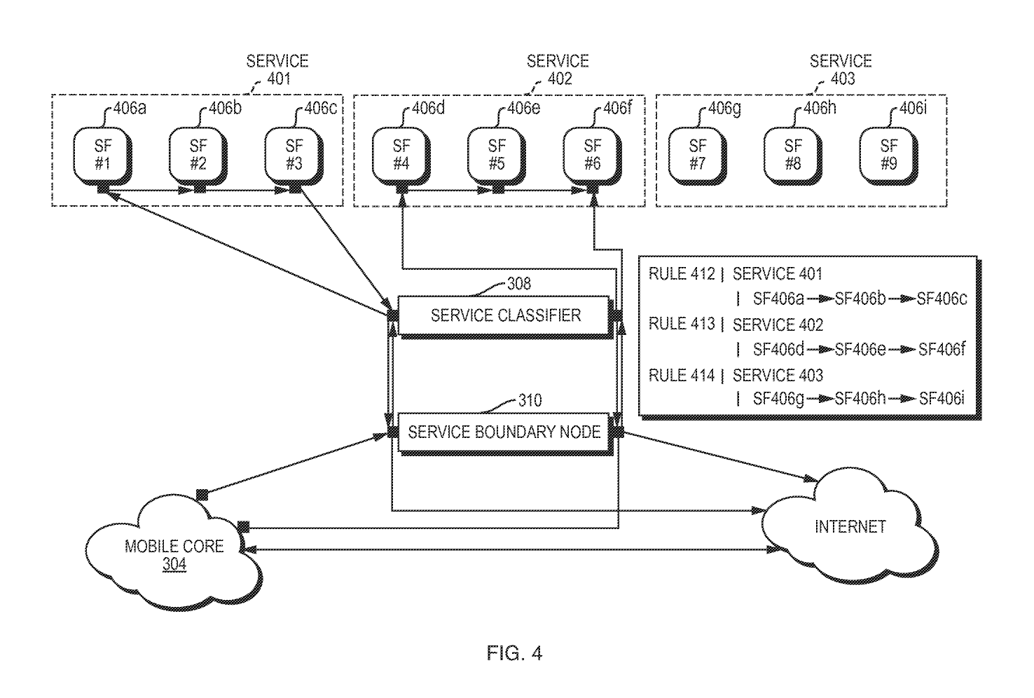

FIG. 4 illustrates in more detail an embodiment of a service chaining architecture within the service provider platform 300 of FIG. 3. The service chaining architecture of FIG. 4 provides a framework for dynamic and agile inclusion, modification, and/or deletion of services based on business needs of a network operator. Many of the elements in FIG. 4 correspond to those introduced with respect to FIG. 3, but will now be described in additional detail.

In FIG. 4, the service function (SF) nodes 406a-i are like the SF nodes 306a-n shown in FIG. 3 and perform the same role, but have been allocated to particular service function chains illustrated in FIG. 4. As noted, a service function is generally responsible for performing a particular action or processing on incoming traffic, e.g., one or more packets. The value-added service offered by the service provider platform 300 typically involves chaining together one or more service function. A service function has a type describing what function it performs or is capable of performing. A service function is preferably identified by a service function identifier that is unique in the domain. Multiple instances of the same service function type may be (and preferably are) running in the platform 300 at a given time, to provide scale and high availability. Each service function instance is preferably identified by a unique service function instance ID in the system. An instance of a service function is hosted in a given node, which may be physical machine or a virtual machine. An instance typically represents an application, process or thread, or grouping thereof, running in such a machine. A service function node is typically associated with a service locator for reachability and service delivery.

Examples of service function types include (some of these apply to mobile applications, other apply more generally):
Blocking Illegal content—for example, some instances of peer to peer traffic.
Parental control
Carrier zero-rated billing rules & differentiated billing rules
Mobile SSL Content adaptation (transcoding, trans-rating, trans-sizing)
Dynamic quality of service (QoS) & traffic flow template (TFT) filtering rules
   For example, setting up bearer channels with specific QoS characteristics for particular traffic, e.g., traffic from or to a particular end-user subscriber's client device.
   This Service Function may aid network elements in prioritizing particular traffic, for example by inserting a code point into downstream traffic that signals a network gateway (e.g., PGW) to apply certain QoS characteristics and thereby select a particular bearer channel.
Header enrichment
Carrier Service (Sponsored data, sponsored ads)
Mobile Device Optimization
VoC (Video over cellular)
Deep packet inspection (DPI)
Firewall
Lawful intercept

The service classifier 308 (also referred to as classifier or SF chain classifier) classifies packets. Preferably it does this based on a packet header or payload contents, according to a policy rule. The rule could specify a statically configured chain of service functions for the given packet header/payload; the rule could also specify that a given set of service functions are to be performed, but allow the service classifier to build the chain dynamically, as is described in more detail below.

Continuing with FIG. 4, the boundary node 310 is preferably a physical or virtual element that connects a given service function chaining domain to another such domain or to a non-service function chaining enabled domain. It typically handles ingress traffic (as the first node to receive traffic from other domains) and/or egress traffic (as the last node to send traffic to other domains). As noted before, in some embodiments, the boundary node 310 is realized in a content server in a CDN, e.g., a deployed proxy cache.

A service function chain (SFC), which is sometimes referred to simply as a ‘service,’ generally defines a set of service functions to be applied to traffic. The order of functions may be linear or parallel. The service classifier populates an SFC by assigning service function instances that will perform each service function in order to create an instance of the SFC. FIG. 4 shows three examples, Services 412, 413, 414. An instance of an SFC is a service function path (SFP). The assigned instances are associated with their host node, and therefore by assigning instances the service classifier is implicitly assigning particular nodes to perform each service function. The particular SFC to use can be selected as result of classification based on policy at the Service Classifier. Multiple instantiations of SFCs may be running simultaneously in the platform 300.

As noted, a service function path (SFP) is an instantiation of a SFC in the network. The path typically starts at the service classifier and steps through the selected service function instances. FIG. 4 illustrates two different SFPs.

Service Function Topology—Multiple topologies are possible for service chaining The selection of a topology can be based on the services and/or based on business continuity. The following exemplary topologies can be supported:
Daisy Chain—In this case, the service function instances have intelligence to forward the packet to the next service function instance (and service function node) as defined in the SFC. The SFC can be dynamically passed along to the service function instance by the service classifier, which would tell the instance where to send the packets next.
Star topology—In this case the service function instances perform the processing and passes the result back to service classifier which takes care of invoking the next service function instance in the path.
Hybrid—a hybrid of daisy chain and star topology can be utilized in which an interconnection layer is interposed between the service classifier and service function instances, acting as a cross connect. Service function instances return packets to the interconnection layer, which then routes the packets to the next service function instance in the path.

Service Function as a sink—In this topology, the Service Function instance gets the packet from the service classifier (or other service functions) and consumes it totally without forwarding it further. An example of such a service function is in case of lawful intercept.

Metadata Transport

The mobile network and the service platform 300 can communicate subscriber and services metadata to facilitate the delivery of value-added services to mobile network subscribers, e.g., providing services in the manner illustrated with respect to FIGS. 3-4. Such metadata can flow out from the mobile network to the service platform, so as to inform the platform about the identity and characteristics of the subscriber, device and/or application for which services will be provided (referred to herein as ‘subscriber/device/app metadata’ for convenience). Notably, however, metadata also can flow from the service platform to the mobile network, so as to inform the mobile network operator about what services were provided for which subscribers, and/or certain results of such services being applied to the traffic (collectively referred to herein as ‘results metadata’ for convenience).

Upstream Traffic with Metadata.

In the upstream direction, a variety of subscriber/device/app metadata may be sent from the PGW, such as:
Identifying Information
   International Mobile Subscriber Identity (IMSI)
   International Mobile Equipment Identifier (IMEI)
   UE's internal IP address (IP address used internal to mobile network)
   Subscriber identity/profile
Descriptive Information (describing characteristics of UE)
   Device Information, such as mobile device make, model, operating system and version, patch image version, and other information that might be found in a user-agent header. Data connection profile such as connection type (e.g., GPRS, etc.).
   Location information

Such subscriber/device/app metadata can be sent to an element in the service platform 300 that processes traffic from the UE. In other words, a boundary node 310 might receive subscriber/device/app metadata from PGW, and include it with messages sent to the classifier 308, which then includes it to a service function path so that the metadata propagates to each SF node and instance in the chain. Either the control plane or data plane can be used to communicate the subscriber/device/app metadata within the platform 300.

Inclusion of subscriber/device/app metadata in the upstream bound traffic can be accomplished in several ways. The metadata can be inserted into headers by the UE device itself, or by the PGW prior to sending a packet out on the wire towards the service platform 300. PGW can send the metadata in-band, with the data traffic, or via an out-of-band mechanism/interface.

Examples of techniques for providing metadata are below:
Browsers or apps on a UE can include X-token header in outbound HTTP traffic that specifies their IMSI/IMEI code or other subscriber/device/app metadata as set forth above. PGW can include X-header in all the upstream bound HTTP traffic.
PGW can insert the aforementioned X-token in outbound HTTP traffic (assuming the traffic is not encrypted).
If PGW is sending the traffic over MPLS LSPs, a new MPLS label can be added to the stack identifying existence of a ‘Metadata header’ between MPLS label and the IP headers. This ‘Metadata header’ can include the subscriber/device/app metadata. See MPLS Generic Associated Channel (IETF, RFC 5586) for additional details on embedding MPLS packets with metadata.
If the traffic egressing PGW is IP packet with 20 byte standard header followed by payload, then subscriber/device/app metadata can be added using techniques discussed in the IETF draft “Metadata Considerations” for Service Function Chaining (Internet Draft August 2014).
The metadata and the original packet or original payload can be encapsulated with GRE encapsulation with mutually agreed ‘key’ values. The key is a field in the GRE header. GRE is defined by IETF RFC 2784.
PGW can offer a RESTful API to service platform 300 to obtain the metadata. In this way, any element in the service platform might obtain the metadata it needs, preferably caching it for some period of time.
An out of band VPN tunnel can be established between PGW and boundary node as the control channel to exchange the metadata.

Downstream Traffic with Metadata.

Results metadata, can be included in packets sent downstream from the service platform to the mobile network and UE. For example, the boundary node, the Provisioning/Control Admin element, or other network element in the service platform 300, can send any or all of the following metadata:
Results metadata examples
   Content source's (origin server) IP address (e.g., if boundary node retrieves content from an origin server and then sends it to mobile network)
   Matched DPI tokens from DPI service function, or other result of DPI analysis
   A content URL (e.g., the requested URL or a URL in the HTTP request body)
   An embedded URL found by a DPI service function in the decrypted payload; the actions taken by the DPI function (e.g., blocking the traffic); and, the amount of data served if the traffic was not blocked
   Video optimization and/or QoS characteristics that the mobile network should apply for the flow, based on the analysis done in the platform (which would typically be driven by the mobile network operator's specified policy for the traffic).
Subscriber/device/app metadata described previously may be included as well.

The service platform nodes can supply this (downstream) metadata via any of the techniques described previously for providing metadata. The metadata may be sent in band with the traffic back to PGW or out of band. The out of band metadata may be sent for example to the PGW or PCRF or another network element in the mobile network. For example, if the metadata is sent to PCRF, as illustrated in FIG. 3, communication channel Rx-AF can be used for this purpose.

Metadata Use Cases

Some examples of how the metadata can be used are provided below:
As mentioned the service platform 300 can offer value added services such as DPI, firewall/virus protection, parental controls, NAT, etc. With the subscriber/device/app metadata available, the service platform elements (such as the boundary node 310 and/or the classifier 308) can identify the particular services to be applied based on the configuration for that subscriber. The services provided to a given subscriber can be communicated back to the mobile network 304 for charging.
In addition, the service function instances on the SF nodes 306 can use subscriber/device/app metadata in processing traffic. For example, these instances may obtain subscriber profiles from the mobile network and offer services such as parental controls in accordance therewith. For example, the instance may obtain subscriber profiles, and then match those profiles when a particular job arrives from the service classifier (or previous hop SF node) with included subscriber/device/app metadata that indicates what subscriber the traffic relates to. As another example, subscriber preferences can be used by a service function to provide specific video services.
With metadata in the incoming packets, the service function instances can collect analytics by subscriber.
In some cases, the service platform 300 can signal for the setup of a bearer that will push particular content (e.g., from a given content provider) to particular subscribers without them having to request it, as it delivers that content to the mobile network.

While the subject matter hereof has been described with reference to a service platform 300, it should be appreciated that the teachings hereof apply without limitation to any external data network 702. That is, results metadata can be exchanged between the mobile network elements and any data network element.

Packet Processing Flow

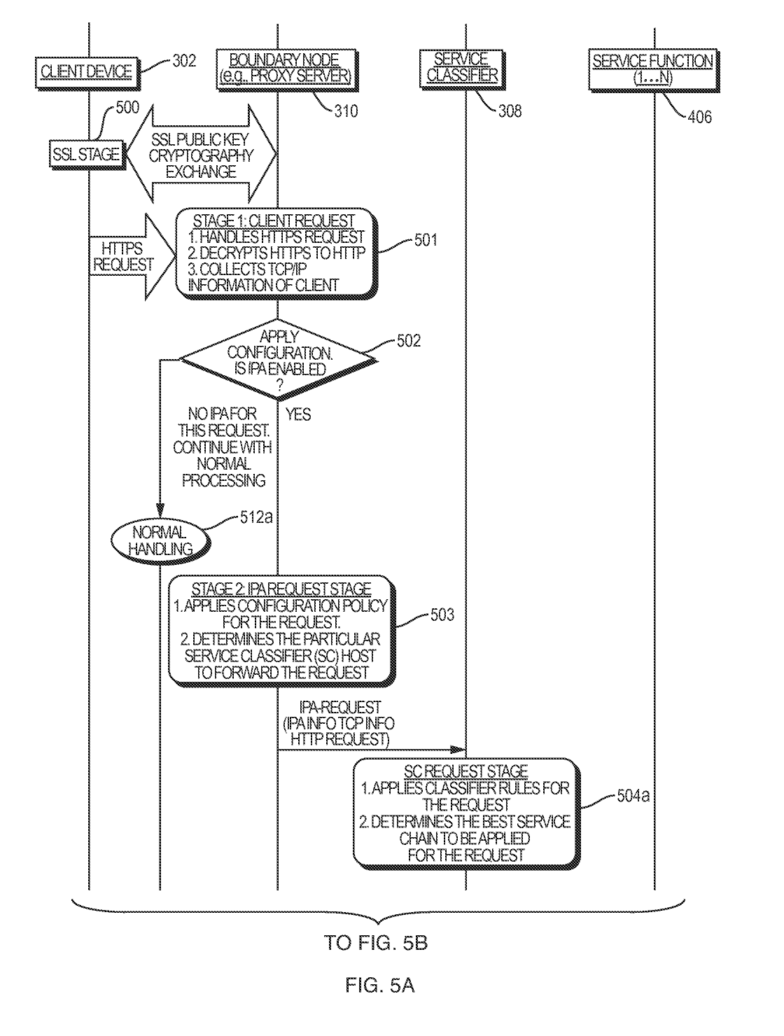

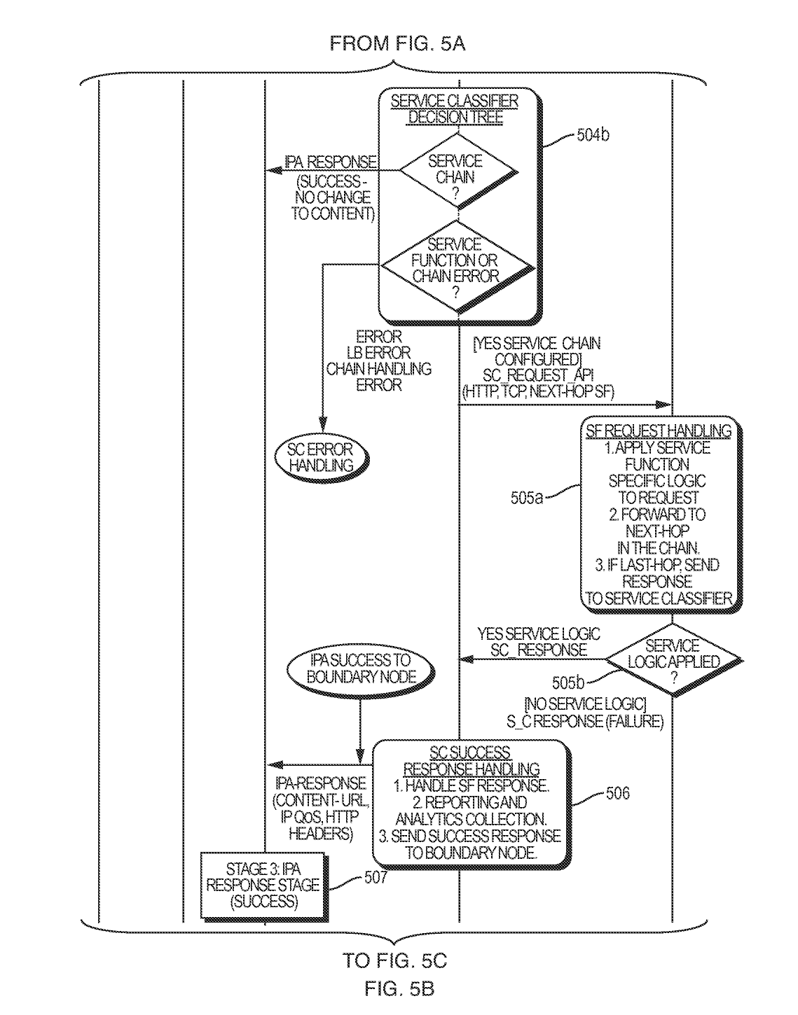

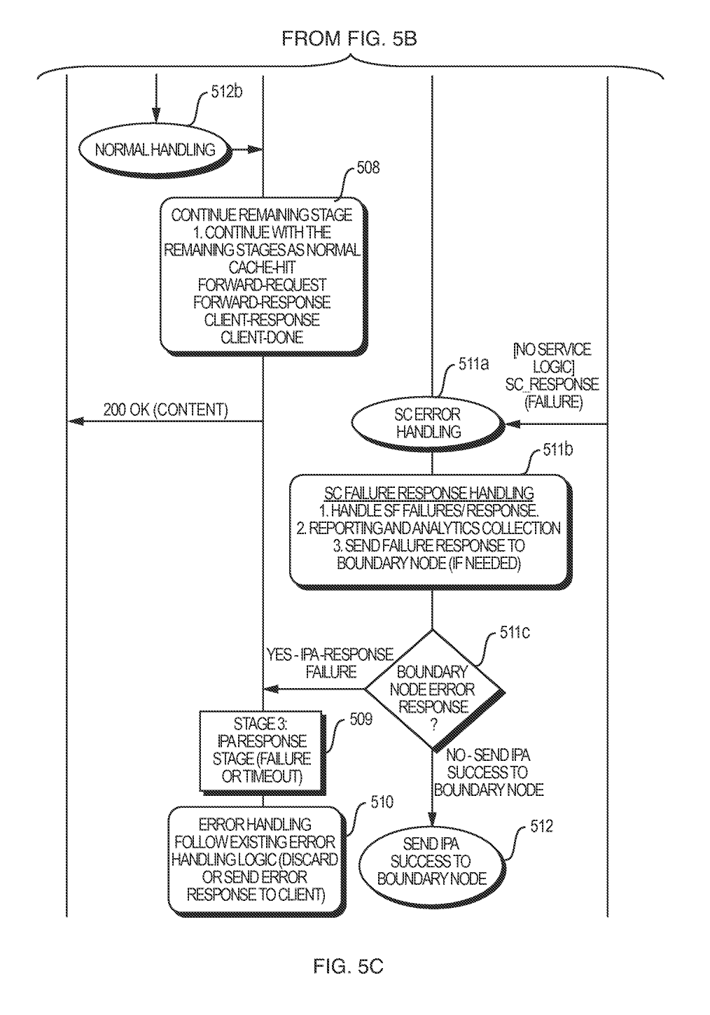

FIGS. 5A-C illustrates packet flow in the example system shown in FIG. 4. As mentioned previously, the boundary node 310 is preferably a proxy server, running for example an HTTP proxy with a local content cache (caching proxy). In the course of handling a client message (e.g., an HTTP request), the proxy server leverages a routine referred to in FIGS. 5A-B as an intermediate processing agent (IPA), which enables the proxy server to initiate a subsidiary processing stage. The IPA stage invokes the service classifier 308 and initiates the service function chain, with the results of SFC processing returned to the proxy server, which then completes its response.

FIGS. 5A-C illustrates the situation where service function chaining is performed on upstream traffic. Along those lines, it illustrates receiving a client device request, invoking an IPA stage and a service function chain on the request and/or data contained therein, and then returning the result for proxy server processing. Then, proxy server processing continues with ‘normal’ processing, e.g., checking cache, making a forward request to origin where there is a cache miss, and the like.

As those skilled in the art will appreciate, to apply service function chaining on downstream traffic (e.g., on a response from an origin server or other server upstream to the boundary node 310), the IPA stage can be invoked after receiving the downstream traffic, and function analogously to what is shown and described with respect to FIGS. 5A-C. The downstream packets can be pushed through a service function chain, and then returned to the proxy server process. Then, the proxy server would transmit them to the client, optionally caching the response for use in responding to subsequent requests if the response is considered cacheable.

Referring to FIG. 5A and in more detail for the upstream case, the process begins with the client device (e.g., a mobile device 302) executing a conventional SSL/TLS handshake with the boundary node/proxy server 310. (See Stage 500.) The client device then sends an encrypted HTTPS request to the proxy server. (Stage 501) The proxy server has the ability to decrypt the traffic. This may be accomplished in a variety of ways, as mentioned previously: for example, the boundary node may have access to the certificate and private key for the origin that the client device is trying to contact, and/or an ability to decrypt traffic as specified in U.S. Patent Publication No. 2013/0156189, the content of which are incorporated by reference. Note that the service platform 300 typically supports content delivery for many different content providers—particularly in the CDN use case—and thus preferably has or has access to the corresponding certificate and SSL/TLS key for each. Thus the proxy server may be able to decrypt traffic that represents requests for content from many different content providers. This itself is a value-add to the network operator, which often does not have the ability to decrypt the traffic as it lacks the necessary security information. Of course, the system can also support unencrypted HTTP traffic (or other application layer traffic).

Returning to FIG. 5A, the proxy server examines the request and applies a configuration setting that specifies how the request should be handled. (Stage 502.) Assume that the configuration dictates that the request should be processed in the service platform 300. Note that in one embodiment, the configuration may be expressed in a configuration file using a flexible metadata language-based approach (written using XML for example) that enables custom configuration for each content provider/network operator. This configuration file may be distributed to proxy servers using a metadata control system established for that purpose. An example of a metadata control system is provided in U.S. Pat. No. 7,240,100, the teachings of which are hereby incorporated by reference.

Assume that based on the configuration, an IPA stage is invoked. (Stage 503.) (Otherwise normal proxy server processing would continue at 512a-b.) The proxy server determines the best service classifier (in the case where there are multiple service classifiers) to forward the request (e.g., based on distance, load, capabilities, originating mobile network & network operator, etc.). IPA stage then proceeds by communicating the request, potentially with certain other information as shown, to the service classifier.

The service classifier applies rules and determines the appropriate service function chain. (SC Request Stage 504a-b.) The classifier invokes the SFC as shown in FIG. 5B, sending the client's request to the first service function instance, along with other information such as IP and TCP header data. The client request is processed node by node in the SFC (505a-b), and if successful returned to the service classifier, which then provides the response to the IPA routine, and also performs logging and analytics. (SC Success Response Handling 506.) As noted previously, in some cases the service platform 300 has a communication channel to the PCRF (see, e.g., FIG. 3, Interface to PCRF and Provisioning/Control 312).

The proxy server finishes the IPA stage successfully and then continues with remaining stages, which are typically conventional proxy server operations like checking local cache for the content, as shown in the Figure. (See Stage 507, 508, 509, 510—Success and Continue Remaining Stage.)

FIGS. 5A-C also illustrate error handling situations in which, for example, the service function instances in the chain fail and/or generate an error response when processing the request. In some cases, these error responses may be propagated up to the proxy server/boundary node process (see SC Failure Response Handling and Stage 511 a-c—failure or timeout). In other cases, it is not necessary to tell the proxy server/boundary node, for example because the error response does not affect the response given to the boundary node—so a ‘success’ value is returned from the IPA stage (512).

Content Distribution Networks

One kind of distributed computer system is a “content delivery network” or “CDN” that is operated and managed by a service provider. The service provider typically provides the content delivery service on behalf of third parties. A “distributed system” of this type typically refers to a collection of autonomous computers linked by a network or networks, together with the software, systems, protocols and techniques designed to facilitate various services, such as content delivery or the support of outsourced site infrastructure. This infrastructure is shared by multiple tenants, the content providers. The infrastructure is generally used for the storage, caching, or transmission of content—such as web pages, streaming media and applications—on behalf of such content providers or other tenants. The platform may also provide ancillary technologies used therewith including, without limitation, DNS query handling, provisioning, data monitoring and reporting, content targeting, personalization, and business intelligence.

According to this disclosure, the assets of a CDN platform may be leveraged to provide the service provider platform 300 described above. More details about CDN platforms in general are provided below.

In a known system such as that shown in FIG. 1, a distributed computer system 100 is configured as a content delivery network (CDN) and has a set of servers 102 distributed around the Internet. Typically, most of the servers are located near the edge of the Internet, i.e., at or adjacent end user access networks. A network operations command center (NOCC) 104 may be used to administer and manage operations of the various machines in the system. Third party sites affiliated with content providers, such as web site 106, offload delivery of content (e.g., HTML or other markup language files, embedded page objects, streaming media, software downloads, and the like) to the distributed computer system 100 and, in particular, to the CDN servers (which are sometimes referred to as content servers, or sometimes as “edge” servers in light of the possibility that they are near an “edge” of the Internet). Such servers may be grouped together into a point of presence (POP) 107 at a particular geographic location.

The CDN servers 102 are typically located at nodes that are publicly-routable on the Internet, in end-user access networks, peering points, within or adjacent nodes that are located in mobile networks, in or adjacent enterprise-based private networks, or in any combination thereof.

Typically, content providers offload their content delivery by aliasing (e.g., by a DNS CNAME) given content provider domains or sub-domains to domains that are managed by the service provider's authoritative domain name service. The server provider's domain name service directs end user client machines 122 that desire content to the distributed computer system (or more particularly, to one of the CDN servers in the platform) to obtain the content more reliably and efficiently. The CDN servers 102 respond to the client requests, for example by fetching requested content from a local cache, from another CDN server, from the origin server 106 associated with the content provider, or other source, and sending it to the requesting client.

For cacheable content, CDN servers 102 typically employ on a caching model that relies on setting a time-to-live (TTL) for each cacheable object. After it is fetched, the object may be stored locally at a given CDN server until the TTL expires, at which time is typically revalidated or refreshed from the origin server 106. For non-cacheable objects (sometimes referred to as ‘dynamic’ content), the CDN server typically returns to the origin server 106 time when the object is requested by a client. The CDN may operate a server cache hierarchy to provide intermediate caching of customer content in various CDN servers that are between the CDN server handling a client request and the origin server 106; one such cache hierarchy subsystem is described in U.S. Pat. No. 7,376,716, the disclosure of which is incorporated herein by reference.

Although not shown in detail in FIG. 1, the distributed computer system may also include other infrastructure, such as a distributed data collection system 108 that collects usage and other data from the CDN servers, aggregates that data across a region or set of regions, and passes that data to other back-end systems 110, 112, 114 and 116 to facilitate monitoring, logging, alerts, billing, management and other operational and administrative functions. Distributed network agents 118 monitor the network as well as the server loads and provide network, traffic and load data to a DNS query handling mechanism 115. A distributed data transport mechanism 120 may be used to distribute control information (e.g., metadata to manage content, to facilitate load balancing, and the like) to the CDN servers. The CDN may include a network storage subsystem which may be located in a network datacenter accessible to the CDN servers and which may act as a source of content, such as described in U.S. Pat. No. 7,472,178, the disclosure of which is incorporated herein by reference.

As illustrated in FIG. 2, a given machine 200 in the CDN comprises commodity hardware (e.g., a microprocessor) 202 running an operating system kernel (such as Linux® or variant) 204 that supports one or more applications 206a-n. To facilitate content delivery services, for example, given machines typically run a set of applications, such as an HTTP proxy 207, a name service 208, a local monitoring process 210, a distributed data collection process 212, and the like. The HTTP proxy 207 (sometimes referred to herein as a global host or “ghost”) typically includes a manager process for managing a cache and delivery of content from the machine. For streaming media, the machine may include one or more media servers, such as a Windows® Media Server (WMS) or Flash server, as required by the supported media formats.

A given CDN server 102 shown in FIG. 1 may be configured to provide one or more extended content delivery features, preferably on a domain-specific, content-provider-specific basis, preferably using configuration files that are distributed to the CDN servers using a configuration system. A given configuration file preferably is XML-based and includes a set of content handling rules and directives that facilitate one or more advanced content handling features. The configuration file may be delivered to the CDN server via the data transport mechanism. U.S. Pat. Nos. 7,240,100, the contents of which are hereby incorporated by reference, describe a useful infrastructure for delivering and managing CDN server content control information and this and other control information (sometimes referred to as “metadata”) can be provisioned by the CDN service provider itself, or (via an extranet or the like) the content provider customer who operates the origin server. U.S. Pat. Nos. 7,111,057, incorporated herein by reference, describes an architecture for purging content from the CDN. More information about a CDN platform can be found in U.S. Pat. Nos. 6,108,703 and 7,596,619, the teachings of which are hereby incorporated by reference in their entirety.

In a typical operation, a content provider identifies a content provider domain or sub-domain that it desires to have served by the CDN. When a DNS query to the content provider domain or sub-domain is received at the content provider's domain name servers, those servers respond by returning the CDN hostname (e.g., via a canonical name, or CNAME, or other aliasing technique). That network hostname points to the CDN, and that hostname is then resolved through the CDN name service. To that end, the CDN name service returns one or more IP addresses. The requesting client application (e.g., browser) then makes a content request (e.g., via HTTP or HTTPS) to a CDN server machine associated with the IP address. The request includes a host header that includes the original content provider domain or sub-domain. Upon receipt of the request with the host header, the CDN server checks its configuration file to determine whether the content domain or sub-domain requested is actually being handled by the CDN. If so, the CDN server applies its content handling rules and directives for that domain or sub-domain as specified in the configuration. These content handling rules and directives may be located within an XML-based “metadata” configuration file, as mentioned previously.

The CDN platform may be considered an overlay across the Internet on which communication efficiency can be improved. Improved communications on the overlay can help when a CDN server needs to obtain content from a origin server 106, or otherwise when accelerating non-cacheable content for a content provider customer. Communications between CDN servers and/or across the overlay may be enhanced or improved using improved route selection, protocol optimizations including TCP enhancements, persistent connection reuse and pooling, content & header compression and de-duplication, and other techniques such as those described in U.S. Pat. Nos. 6,820,133, 7,274,658, 7,607,062, and 7,660,296, among others, the disclosures of which are incorporated herein by reference.

As an overlay offering communication enhancements and acceleration, the CDN server resources may be used to facilitate wide area network (WAN) acceleration services between enterprise data centers and/or between branch-headquarter offices (which may be privately managed), as well as to/from third party software-as-a-service (SaaS) providers used by the enterprise users.

In this vein CDN customers may subscribe to a “behind the firewall” managed service product to accelerate Intranet web applications that are hosted behind the customer's enterprise firewall, as well as to accelerate web applications that bridge between their users behind the firewall to an application hosted in the internet cloud (e.g., from a SaaS provider).

To accomplish these two use cases, CDN software may execute on machines (potentially in virtual machines running on customer hardware) hosted in one or more customer data centers, and on machines hosted in remote “branch offices.” The CDN software executing in the customer data center typically provides service configuration, service management, service reporting, remote management access, customer SSL/TLS certificate management, as well as other functions for configured web applications. The software executing in the branch offices provides last mile web acceleration for users located there. The CDN itself typically provides CDN hardware hosted in CDN data centers to provide a gateway between the nodes running behind the customer firewall and the CDN service provider's other infrastructure (e.g., network and operations facilities). This type of managed solution provides an enterprise with the opportunity to take advantage of CDN technologies with respect to their company's intranet, providing a wide-area-network optimization solution. This kind of solution extends acceleration for the enterprise to applications served anywhere on the Internet. By bridging an enterprise's CDN-based private overlay network with the existing CDN public internet overlay network, an end user at a remote branch office obtains an accelerated application end-to-end. More information about a behind the firewall service offering can be found in teachings of U.S. Pat. No. 7,600,025, the teachings of which are hereby incorporated by reference.

For live streaming delivery, the CDN may include a live delivery subsystem, such as described in U.S. Pat. No. 7,296,082, and U.S. Publication Nos. 2011/0173345 and 2012/0265853, the disclosures of which are incorporated herein by reference.

Computer Based Implementation

The subject matter described herein may be implemented with computer systems, as modified by the teachings hereof, with the processes and functional characteristics described herein realized in special-purpose hardware, general-purpose hardware configured by software stored therein for special purposes, or a combination thereof.

Software may include one or several discrete programs. A given function may comprise part of any given module, process, execution thread, or other such programming construct. Generalizing, each function described above may be implemented as computer code, namely, as a set of computer instructions, executable in one or more microprocessors to provide a special purpose machine. The code may be executed using conventional apparatus—such as a microprocessor in a computer, digital data processing device, or other computing apparatus—as modified by the teachings hereof In one embodiment, such software may be implemented in a programming language that runs in conjunction with a proxy on a standard Intel hardware platform running an operating system such as Linux. The functionality may be built into the proxy code, or it may be executed as an adjunct to that code.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

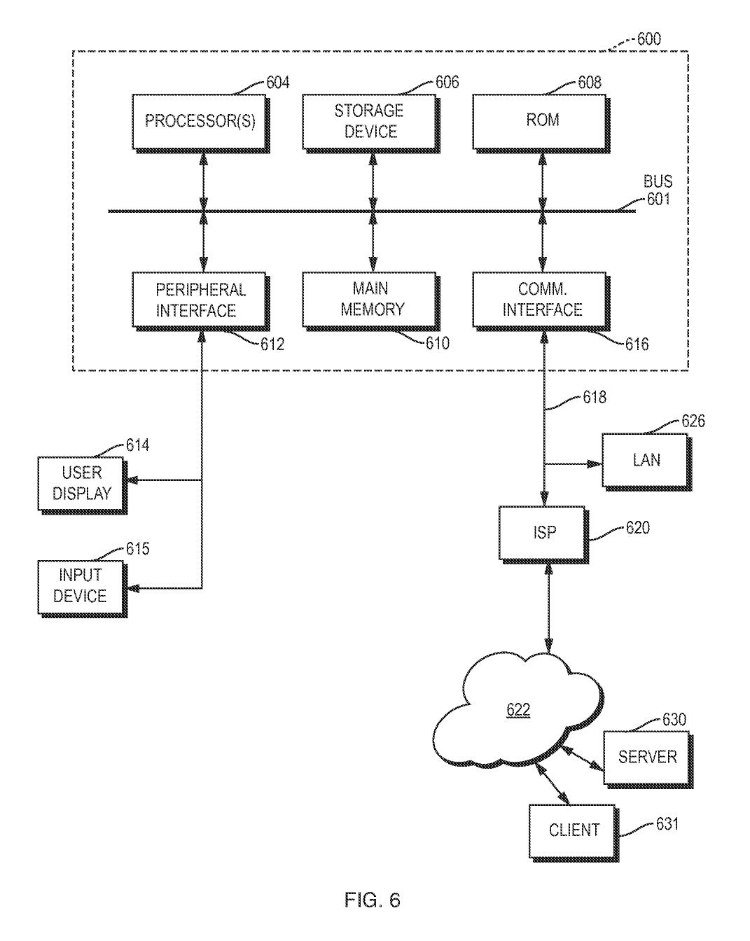

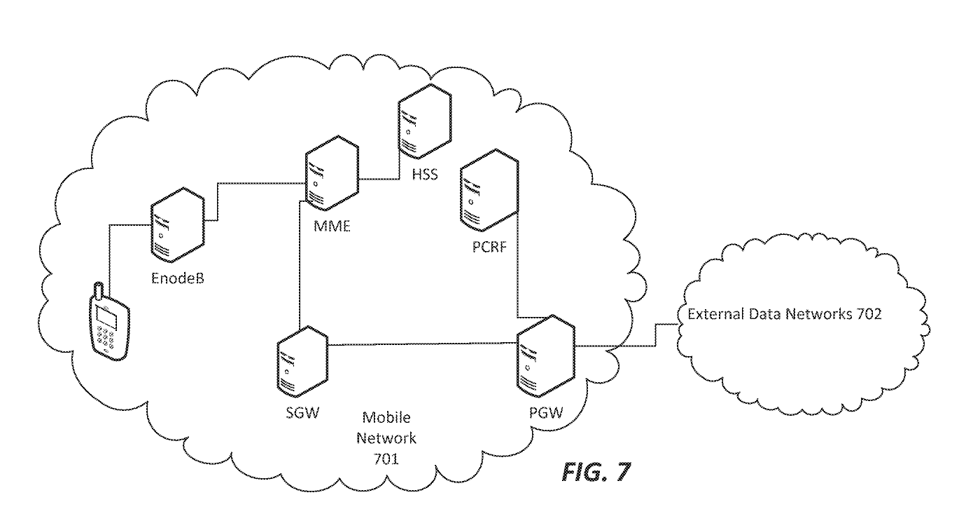

FIG. 6 is a block diagram that illustrates hardware in a computer system 600 on which embodiments of the invention may be implemented. A physical node in the system may be implemented with computer system 600; a virtual node may be implemented on the computer system with appropriate middleware (e.g., hypervisor) to manage the virtual machine. The computer system 600 may be embodied in a client device, server, personal computer, workstation, tablet computer, wireless device, mobile device, network device, router, hub, gateway, or other device.

Computer system 600 includes a microprocessor 604 coupled to bus 601. In some systems, multiple microprocessor and/or microprocessor cores may be employed. Computer system 600 further includes a main memory 610, such as a random access memory (RAM) or other storage device, coupled to the bus 601 for storing information and instructions to be executed by microprocessor 604. A read only memory (ROM) 608 is coupled to the bus 601 for storing information and instructions for microprocessor 604. As another form of memory, a non-volatile storage device 606, such as a magnetic disk, solid state memory (e.g., flash memory), or optical disk, is provided and coupled to bus 601 for storing information and instructions. Other application-specific integrated circuits (ASICs), field programmable gate arrays (FPGAs) or circuitry may be included in the computer system 600 to perform functions described herein.

Although the computer system 600 is often managed remotely via a communication interface 616, for local administration purposes the system 600 may have a peripheral interface 612 communicatively couples computer system 600 to a user display 614 that displays the output of software executing on the computer system, and an input device 615 (e.g., a keyboard, mouse, trackpad, touchscreen) that communicates user input and instructions to the computer system 600. The peripheral interface 612 may include interface circuitry and logic for local buses such as Universal Serial Bus (USB) or other communication links.

Computer system 600 is coupled to a communication interface 616 that provides a link between the system bus 601 and an external communication link. The communication interface 616 provides a network link 618. The communication interface 616 may represent an Ethernet or other network interface card (NIC), a wireless interface, modem, an optical interface, or other kind of input/output interface.

Network link 618 provides data communication through one or more networks to other devices. Such devices include other computer systems that are part of a local area network (LAN) 626. Furthermore, the network link 618 provides a link, via an internet service provider (ISP) 620, to the Internet 622. In turn, the Internet 622 may provide a link to other computing systems such as a remote server 630 and/or a remote client 631. Network link 618 and such networks may transmit data using packet-switched, circuit-switched, or other data-transmission approaches.

In operation, the computer system 600 may implement the functionality described herein as a result of the microprocessor executing program code. Such code may be read from or stored on a non-transitory computer-readable medium, such as memory 610, ROM 608, or storage device 606. Other forms of non-transitory computer-readable media include disks, tapes, magnetic media, CD-ROMs, optical media, RAM, PROM, EPROM, and EEPROM. Any other non-transitory computer-readable medium may be employed. Executing code may also be read from network link 618 (e.g., following storage in an interface buffer, local memory, or other circuitry).

A client device may be a conventional desktop, laptop or other Internet-accessible machine running a web browser or other rendering engine, but as mentioned above a client may also be a mobile device. Any wireless client device may be utilized, e.g., a cellphone, pager, a personal digital assistant (PDA, e.g., with GPRS NIC), a mobile computer with a smartphone client, tablet or the like. Other mobile devices in which the technique may be practiced include any access protocol-enabled device (e.g., iOS™-based device, an Android™-based device, other mobile-OS based device, or the like) that is capable of sending and receiving data in a wireless manner using a wireless protocol. Typical wireless protocols include: WiFi, GSM/GPRS, CDMA or WiMax. These protocols implement the ISO/OSI Physical and Data Link layers (Layers 1 & 2) upon which a traditional networking stack is built, complete with IP, TCP, SSL/TLS and HTTP. The WAP (wireless access protocol) also provides a set of network communication layers (e.g., WDP, WTLS, WTP) and corresponding functionality used with GSM and CDMA wireless networks, among others.

In a representative embodiment, a mobile device is a cellular telephone that operates over GPRS (General Packet Radio Service), which is a data technology for GSM networks. Generalizing, a mobile device as used herein is a 3G-(or next generation) compliant device that includes a subscriber identity module (SIM), which is a smart card that carries subscriber-specific information, mobile equipment (e.g., radio and associated signal processing devices), a man-machine interface (MMI), and one or more interfaces to external devices (e.g., computers, PDAs, and the like). The techniques disclosed herein are not limited for use with a mobile device that uses a particular access protocol. The mobile device typically also has support for wireless local area network (WLAN) technologies, such as Wi-Fi. WLAN is based on IEEE 802.11 standards. The teachings disclosed herein are not limited to any particular mode or application layer for mobile device communications.

It should be understood that the foregoing has presented certain embodiments of the invention that should not be construed as limiting. For example, certain language, syntax, and instructions have been presented above for illustrative purposes, and they should not be construed as limiting. It is contemplated that those skilled in the art will recognize other possible implementations in view of this disclosure and in accordance with its scope and spirit. The appended claims define the subject matter for which protection is sought.

It is noted that trademarks appearing herein are the property of their respective owners and used for identification and descriptive purposes only, given the nature of the subject matter at issue, and not to imply endorsement or affiliation in any way.

1. A method executable in a service platform external to a mobile network, the service platform comprising one or more computing machines, the method comprising:
receiving, from a mobile network gateway, one or more packets holding data originating from a mobile client device, the one or more packets being received at a network element in a service platform, the service platform being in a network external to the mobile network;
processing the one or more packets to provide a service to the mobile network;
sending the processed one or more packets to any of: (i) the mobile network gateway, for delivery to the mobile client device, and (ii) an origin server associated with a content provider, the origin server being distinct from the service platform;
sending results metadata to a network element in the mobile network, to reflect the service provided;
wherein the results metadata comprises any of:
(a) the origin server IP address,
(b) at least a portion of a URL extracted from the one or more packets,
(c) one or more matched tokens from a deep packet inspection process,
(d) an indicator of an action taken by the service platform with respect to the one or more packets.

2. The method of claim 1, wherein the data in the one or more packets is encrypted, the method further comprising: decrypting the data in the one or more packets, and processing the one or more packets by processing the data after decryption.

3. The method of claim 2, wherein the data is encrypted in accordance with a SSL/TLS session between the mobile client device and the network element in the service platform.

4. The method of claim 1, wherein the network element in the service platform comprises a proxy server with a local content cache.

5. The method of claim 1, wherein the network element in the service platform comprises a content server in a content delivery network.

6. The method of claim 1, wherein the results metadata comprises: the origin server IP address.

7. The method of claim 1, wherein the results metadata comprises: at least a portion of a URL extracted from the one or more packets.

8. The method of claim 1, wherein the results metadata comprises: one or more matched tokens from a deep packet inspection process.

9. The method of claim 1, wherein the results metadata comprises: an indicator of an action taken by the service platform with respect to the one or more packets.

10. The method of claim 1, wherein the processing the one or more packets comprises transmitting the one or more packets through a service function chain.

11. A method executable in a service platform external to a mobile network, the service platform comprising one or more computing machines, the method comprising:
receiving, from a mobile network gateway, one or more packets holding data originating from a mobile client device, the one or more packets being received at a network element in a service platform, the service platform being in a network external to the mobile network;
processing the one or more packets to provide a service to the mobile network;
sending the processed one or more packets to any of: (i) the mobile network gateway, for delivery to the mobile client device, and (ii) an origin server associated with a content provider, the origin server being distinct from the service platform;
sending results metadata to a network element in the mobile network, to reflect the service provided;
wherein the results metadata comprises:
an identifier for a source of content that is being requested by the mobile client device.

12. The method of claim 11, wherein the data in the one or more packets is encrypted, the method further comprising: decrypting the data in the one or more packets, and processing the one or more packets by processing the data after decryption.

13. The method of claim 11, wherein the data is encrypted in accordance with a SSL/TLS session between the mobile client device and the network element in the service platform.

14. The method of claim 11, wherein the network element in the service platform comprises a proxy server with a local content cache.

15. The method of claim 11, wherein the network element in the service platform comprises a content server in a content delivery network.

16. The method of claim 11, wherein the processing the one or more packets comprises transmitting the one or more packets through a service function chain.

17. A method executable in a service platform external to a mobile network, the service platform comprising one or more computing machines, the method comprising:
receiving, from an origin server, one or more packets holding data to be delivered to a mobile client device, the one or more packets being received at a network element in a service platform, the service platform being in a network external to a mobile network;
processing the one or more packets to provide a service to the mobile network;
sending the processed one or more packets to a mobile network gateway in the mobile network, for delivery to the mobile client device;
sending results metadata to a network element in the mobile network, to reflect the service provided;
wherein the results metadata comprises any of:
(a) an origin server IP address, the origin server being distinct from the service platform,
(b) at least a portion of a URL extracted from the one or more packets,
(c) one or more matched tokens from a deep packet inspection process,
(d) an indicator of an action taken by the service platform with respect to the one or more packets.

18. The method of claim 17, wherein the data in the one or more packets is encrypted, the method further comprising: decrypting the data in the one or more packets, and processing the one or more packets by processing the data after decryption.

19. The method of claim 17, wherein the results metadata comprises: the origin server IP address.

20. The method of claim 17, wherein the results metadata comprises: at least a portion of a URL extracted from the one or more packets.

21. The method of claim 17, wherein the results metadata comprises: one or more matched tokens from a deep packet inspection process.

22. The method of claim 17, wherein the results metadata comprises: an indicator of an action taken by the service platform with respect to the one or more packets.

23.-25. (canceled)
